(19) United States
(12) Patent Application Publication
(10) Pub. No.: US 2021/0221557 A1
(43) Pub. Date: Jul. 22, 2021

(54) SYSTEM FOR TRANSPORTING HOT FOOD

(71) Applicant: Paul J. Forsberg, Naples, FL (US)

(72) Inventor: Paul J. Forsberg, Naples, FL (US)

(21) Appl. No.: 17/154,592

(22) Filed: Jan. 21, 2021

Related U.S. Application Data
(60) Provisional application No. 62/963,946, filed on Jan. 21, 2020.

(51) Int. Cl. B65D 5/56; B32B 15/20; B32B 15/12; B65D 5/42; B65D 5/20; B65D 85/36

(52) U.S. Cl. CPC B65D 5/566; B32B 15/20; B32B 15/12; B65D 5/4216; B32B 2307/724; B65D 85/36; B32B 2439/70; B65D 2585/366; B65D 5/2052

(57) ABSTRACT

A system for addition to a box for transporting hot food includes a first sheet composed of a first layer of nonstick aluminum and a second layer of parchment paper, wherein the second layer of the first sheet is configured for being removably coupled to an interior surface of a top portion of the box, a second sheet composed of a first layer of nonstick aluminum and a second layer of parchment paper, wherein the second layer of the second sheet is configured for being removably coupled to an interior surface of a bottom portion of the box, wherein the first sheet includes a plurality of orifices configured for allowing moisture to escape therethrough.

### CROSS-REFERENCE TO RELATED APPLICATIONS

This patent application claims benefit of provisional patent application number 62963946 filed Jan. 21, 2020, and titled System for Transporting Hot Food. The subject matter of patent application number 62963946 is hereby incorporated by reference in its entirety

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The disclosed embodiments relate to the field of food containers, and more specifically to the field of boxes to transport hot foods from a source location to a predefined destination.

### BACKGROUND

Containers to deliver freshly baked pizzas have existed at least since the 19th century, when Neapolitan pizza bakers put their products in multi-layered metallic containers and then sent them to the street sellers. The aerated container was round and made of tin or copper. Disposable packaging started to be developed in the United States, after the Second World War. At that time pizza was becoming increasingly popular and the first pizza delivery services were created. In the beginning they attempted to deliver pizzas in simple cardboard boxes, similar to those used in cake shops, but these often became wet, bent, or even broke in two. Other pizza chefs tried to put pizzas on plates and transport them inside paper bags. This partly solved the problem. However, it was almost impossible to transport more than a single pizza inside one bag. The first patent for a pizza box made of corrugated cardboard was applied in 1963 and displayed the characteristics of today's pizza packaging: plane blanks, foldability without need of adhesive, stackability and ventilation slots.

Nearly 60 years later, the pizza box design has not evolved much beyond the standard cardboard square. In fact, the pizza box remains a balancing act in proportions, which endeavors to retain just the right amount of heat to keep its contents warm and release the right amount of steam. On the one hand, if the pizza is completely sealed inside the pizza box, the steam released from the pizza will condense and create a soggy crust. On the other hand, if the pizza box has too much ventilation, the pizza will cool. Unfortunately, because the requirements between usability and functionality are often conflicting in nature, it is difficult to find a pizza box encompassing the above-mentioned elements without compromise. As a result, there exists a need for improvements over the prior art and more particularly, for a box that maintains its food contents fresh, crisp, and hot for an extended period of time.

### SUMMARY

A system for addition to a box for transporting hot food is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for addition to a box for transporting hot food is disclosed. The system includes a first sheet composed of a first layer of nonstick aluminum and a second layer of parchment paper, wherein the second layer of the first sheet is configured for being removably coupled to an interior surface of a top portion of the box; a second sheet composed of a first layer of nonstick aluminum and a second layer of parchment paper, wherein the second layer of the second sheet is configured for being removably coupled to an interior surface of a bottom portion of the box; wherein the first sheet includes a plurality of orifices configured for allowing moisture to escape therethrough.

In another embodiment, a system for transporting hot food includes a box having a top portion and a bottom portion, wherein the bottom portion is hingedly attached to the box, and the top portion is configured for opening to gain access to an interior volume of the box; a first sheet composed of a first layer of nonstick aluminum and a second layer of parchment paper, wherein the second layer of the first sheet is configured for being removably coupled to an interior surface of a top portion of the box; a second sheet composed of a first layer of nonstick aluminum and a second layer of parchment paper, wherein the second layer of the second sheet is configured for being removably coupled to an interior surface of a bottom portion of the box; wherein the first sheet includes a plurality of orifices configured for allowing moisture to escape therethrough.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate the claimed embodiments and together with the description, serve to explain the principles of the disclosed embodiments. The embodiments illustrated herein are presently preferred, it being understood, however, that the claimed embodiments are not limited to the precise arrangements and instrumentalities shown, wherein:

FIG. 1 is a front perspective view of a system for transporting hot food, wherein a first set of one or more hermetically sealed pouches filled with cellulose fiber are coupled to an interior surface of a top side of a box, and a second set of one or more hermetically sealed pouches filled with a moisture absorbent material are coupled to an interior surface of a bottom side of the box, according to an example embodiment;

FIG. 2 is a front perspective view of a system for transporting hot food, wherein a heat retaining element is disposed above a second set of one or more hermetically sealed pouches filled with a moisture absorbent material coupled to an interior surface of a bottom side of a box, according to an example embodiment; and

FIG. 3 is a front perspective view of a system for transporting hot food, wherein a food item is disposed above a heat retaining element such that the food item is elevated off the interior surface of the bottom side of the box, according to an example embodiment.

FIG. 4 is a front perspective view of a system for transporting hot food, including sheets that are located on the top and bottom portions of the box, according to an example embodiment;

FIG. 5 provides additional views of the sheets of FIG. 4 according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The claimed embodiments improve upon the prior art by providing a system for transporting hot food that maintains its contents fresh, crisp, and hot for an extended period of time. Although the examples given below describe a system for transporting hot food relative to a pizza, those of skill in the art will appreciate that the claimed embodiments may be adapted for use with other foods, including, but not limited to burritos, burgers, French fries, and nachos.

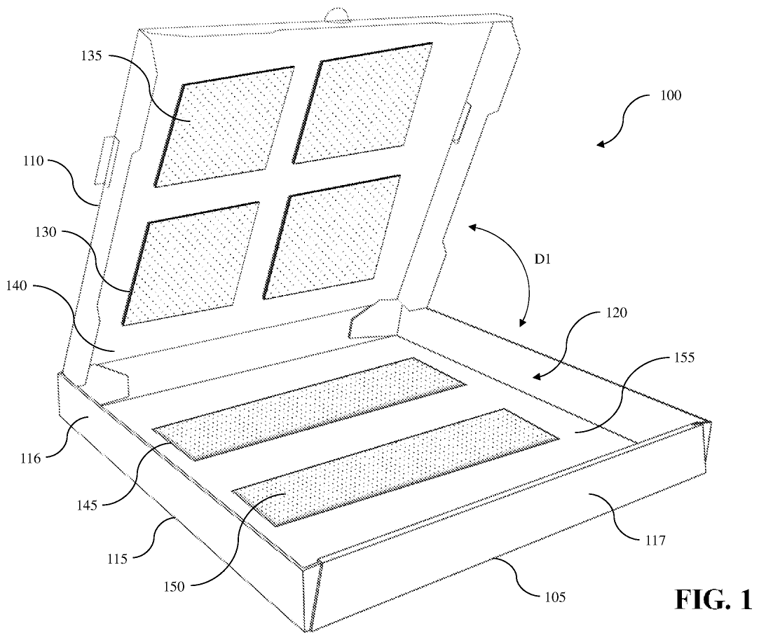

Referring now to the Figures, FIGS. 1-3 illustrate a system 100 for transporting hot food according to an example embodiment and will be discussed together for ease of reference. The system includes a box 105 having a top side 110 and a bottom side 115. The top side 110 of the box defines a first substantially planar surface and the bottom side 115 of the box defines a second substantially planar surface. The bottom side 115 of the box is hingedly attached to the box such that the top side 110 of the box may pivot between an open position and a closed position (in the direction of double arrowed line D1) to allow access to an interior volume 120 of the box 105. The interior volume 120 of the box 105 is formed by two opposing sidewalls 116 and two opposing end walls 117 on the bottom side of the box. The interior volume 120 of the box is configured to provide sufficient area to store at least one food item.

In the present embodiment, the box 105 is generally sized to store a pizza 125, however, it should be appreciated that the box may have other shapes and dimensions to accommodate additional foods, and such variations are within the spirit and scope of the claimed embodiments. The box is preferably comprised from an integral piece of recyclable, non-toxic and food safe paper-based material such as corrugated cardboard or may be similarly comprised of biodegradable or compostable materials such as sugarcane, bamboo, and plant-based materials.

FIG. 1 is a front perspective view of the system wherein a first set of one or more hermetically sealed pouches 130 filled with cellulose fiber 135 are removably coupled to an interior surface 140 of the top side 110 of the box 105, according to an example embodiment. The first set of one or more hermetically sealed pouches 130 filled with cellulose fiber 135 are configured to absorb steam and moisture to prevent the pizza crust from getting soggy. The pouches 130 perform effectively by first absorbing the moisture then trapping it without leaving or exiting the pad.

The first set of one or more hermetically sealed pouches 130 are comprised of impermeable, nonstick material. In one embodiment, the impermeable, nonstick material is comprised of acetate paper that is capable of resisting high temperatures, however, it should be appreciated that other impermeable, nonstick materials may be employed provided that they effectively prevent the top of the pizza from adhering to the first set of one or more hermetically sealed pouches 130. The first set of one or more hermetically sealed pouches 130 are filled with cellulose fibers 135 due to its high-water holding capacity. Cellulose fibers are made with ethers or esters of cellulose, which has a strong affinity to itself and materials containing hydroxyls, especially water. The hydroxyl groups (—OH) of cellulose form strong hydrogen bonds with water molecules which makes it possible to bind a lot of water to the cellulose fibers.

In one embodiment, the first set of one or more hermetically sealed pouches 130 are attached to the interior surface 140 of the top side 110 of the box 105 with a double-sided tape that includes a peelable strip for covering the adhesive. Once peeled away to expose the adhesive underneath the strip, the first set of one or more hermetically sealed pouches 130 may be pressed onto the interior surface 140 of the top side 110 of the box 105. It should be appreciated that other attachment devices may be used to secure the first set of one or more hermetically sealed pouches 130 to the interior surface 140 of the top side 110 of the box 105, including backing materials coated with natural adhesives made from organic sources such as vegetable starch, natural resins, or animals, clamps, brackets, slots, or any other suitable method known in the art.

FIG. 1 further illustrates a front perspective view of the system wherein a second set of one or more hermetically sealed pouches 145 filled with a moisture absorbent material 150 are removably coupled to an interior surface 155 of the bottom side 115 of the box 105, according to an example embodiment. The second set of one or more hermetically sealed pouches 145 filled with the moisture absorbent material 150 are configured to further absorb steam and moisture to prevent the pizza crust from getting soggy. In one embodiment, the one of more hermetically sealed pouches may comprise a bubble wrap film with the moisture absorbent material located inside the film in between the bubbles.

Similar to the first set of one or more hermetically sealed pouches, the second set of one or more hermetically sealed pouches 145 are comprised of impermeable, nonstick material. In one embodiment, the impermeable, nonstick material is comprised of acetate paper that is capable of resisting high temperatures, however, it should be appreciated that other impermeable, nonstick materials may be employed provided that they effectively prevent the bottom of the pizza from adhering to the second set of one or more hermetically sealed pouches 145. In one embodiment, the moisture absorbent material 150 is comprised of a mixture of 70 percent by volume of rock salt and 30 percent by volume of rice. It should be appreciated that other types of moisture absorbent materials, such as silica gel, calcium sulfate, or calcium oxide, may be used to fill the second set of one or more hermetically sealed pouches 145.

Salts ability to preserve food was a founding contributor to the development of civilization. Today, salt is universally accessible, relatively cheap, and often iodized. Salt can be used for reabsorbing moisture after cooking. Salt can be used for prolonging shelf life of foods, drawing out moisture and bacteria. Salt also dries food, draws water out of food and dehydrates it. The claimed embodiment's two-part system absorbs moisture immediately with its cellulose fibers. The claimed embodiment's two-part system also preserves the crispiness of the food. Salt has a positive effect of absorbing and preserving simultaneously, which addresses the damaging conditions of excessive moisture ruining foods, including pizza.

In one embodiment, the second set of one or more hermetically sealed pouches 145 are attached to the interior surface 155 of the bottom side 115 of the box 105 with double-sided tape that includes a peelable strip for covering the adhesive. Once peeled away to expose the adhesive underneath the strip, the second set of one or more hermetically sealed pouches 145 may be pressed onto the interior surface 155 of the bottom side 115 of the box 105. It should be appreciated that other attachment devices may be used to secure the second set of one or more hermetically sealed pouches 145 to the interior surface 155 of the bottom side 115 of the box 105, including backing materials coated with natural adhesives made from organic sources such as vegetable starch, natural resins, or animals, clamps, brackets, slots, or any other suitable method known in the art.

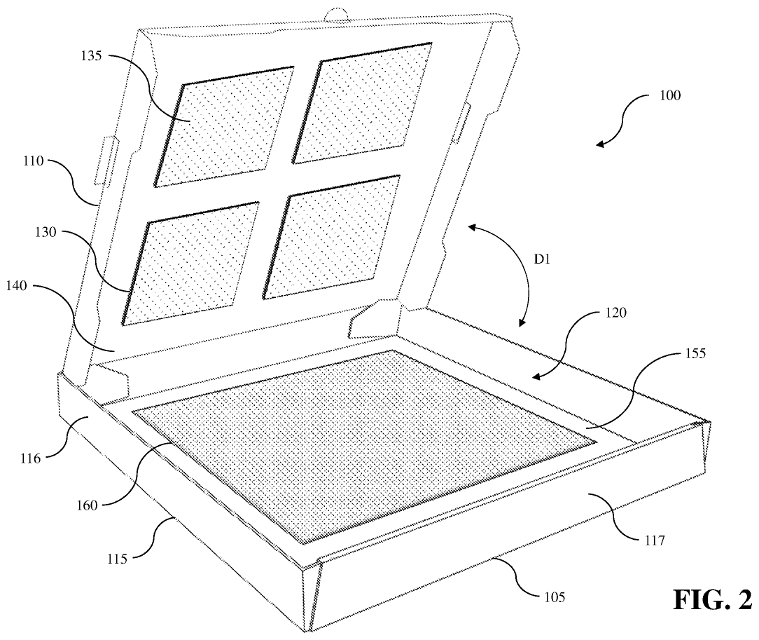

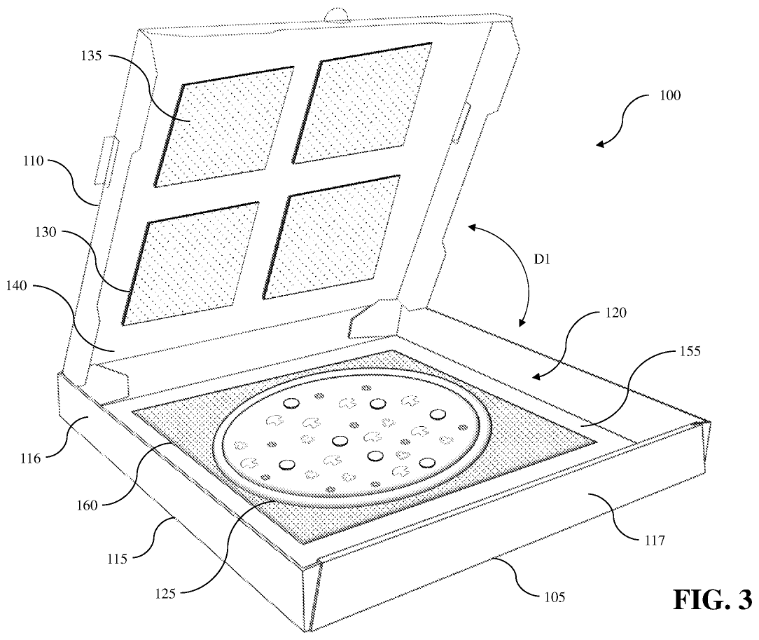

FIG. 2 is a front perspective view of a system for transporting hot food, wherein a heat retaining element 160 is removably disposed above the second set of one or more hermetically sealed pouches 145 filled with the moisture absorbent material 150 coupled to the interior surface 155 of the bottom side 115 of the box 105, according to an example embodiment. The heating element is configured to maintain the freshly prepared pizza 125 warm during transportation, as best illustrated in FIG. 3. In operation, the heat retaining element is removed from the box and preheated while the pizza is baking in an oven. Thereafter, as best illustrated in FIGS. 2 and 3, the heat retaining element 160 is positioned inside the box 105 such that when the hot pizza is removed from the oven and placed directly on the heating element, the pizza 125 is elevated off the interior surface of the bottom side of the box by 1/16 of an inch.

In one embodiment, the heat retaining element is comprised of a mixture of granite chips and quartz chips molded into an elevated sheet. The use of granite chips and quartz chips is significant because it is the result of experimental testing of the claimed embodiments to find the correct heat retaining element sufficient enough to maintain the pizza warm for approximately 30 to 45 minutes. Without departing from the scope of the claimed embodiments, it should be appreciated that depending on certain conditions, such as a specific food item or climate of a particular environment, the heat retaining element 160 may be further comprised of aluminum, ceramic, zeolite, stainless steel, plastic mesh, or any combination thereof to achieve the desired effectiveness.

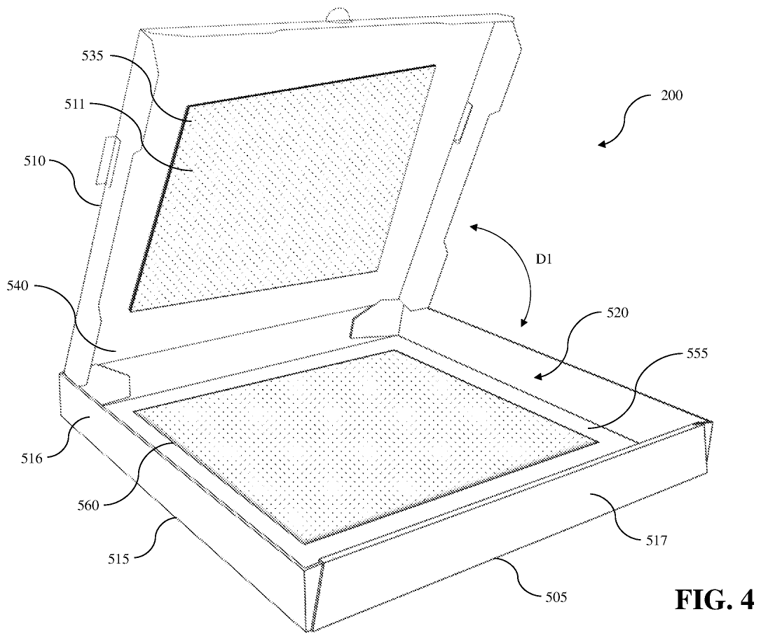

FIG. 4 is a front perspective view of a system 200 for transporting hot food, including sheets 535, 560 that are located on the top 510 and bottom 515 portions of the box, according to an example embodiment. The system 200 includes a box 505 having a top side 510 and a bottom side 515. The top side 510 of the box defines a first substantially planar surface and the bottom side 515 of the box defines a second substantially planar surface. The bottom side 515 of the box is hingedly attached to the box such that the top side 510 of the box may pivot between an open position and a closed position (in the direction of double arrowed line D1) to allow access to an interior volume 520 of the box 505. The interior volume 520 of the box 505 is formed by two opposing sidewalls 516 and two opposing end walls 517 on the bottom side of the box. The interior volume 520 of the box is configured to provide sufficient area to store at least one food item.

A first sheet 535 is removably coupled to an interior surface 540 of the top side 510 of the box 505, according to an example embodiment. A second sheet 560 is removably coupled to an interior surface 555 of the bottom side 515 of the box 505, according to an example embodiment. FIG. 4 shows that the first sheet 535 includes a plurality of orifices 511 configured for allowing moisture to escape therethrough. The second sheet 560 may also include a plurality of orifices 511 configured for allowing moisture to escape therethrough.

FIG. 4 shows that the first sheet 535 is coextensive with the top portion 510 of the box 505. FIG. 4 also shows that the second sheet 560 is coextensive with the bottom portion 515 of the box 505.

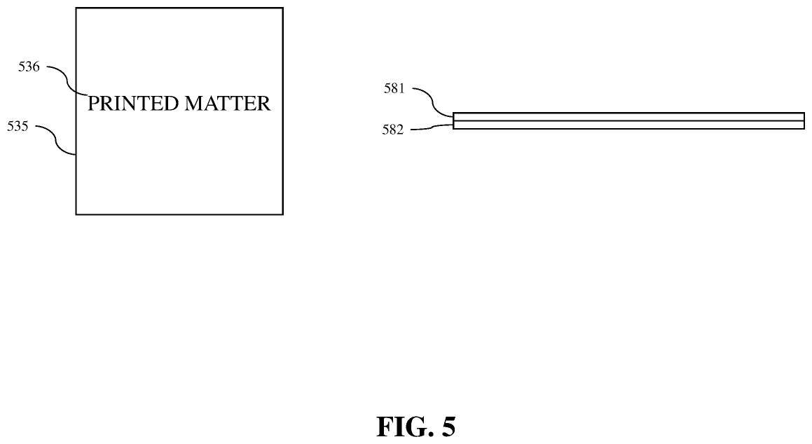

FIG. 5 provides additional views of the sheets 535, 560 of FIG. 4 according to an example embodiment. The sheets 535, 560 may be composed of a first layer 581 of nonstick aluminum and a second layer 582 of parchment paper, wherein the second layer is configured for being removably coupled to an interior surface of the box, such as using an adhesive. In another embodiment, sheets 535, 560 are not coupled to an interior surface of the box but rather simply lie on top of, or under, the food in the box, help in place using solely gravity and friction. The second layer of the sheets 535, 560 may include printed material 536 configured for advertising.

The first layer may be composed of aluminum, i.e., aluminum prepared in thin metal leaves with a thickness less than 0.2 mm (7.9 mils) or thinner gauges down to 6 micrometers (0.24 mils). Aluminum provides insulation, acts as a total barrier to light and oxygen and provides electromagnetic shielding. Parchment paper, baking paper, liners or bakery release paper is cellulose-based paper that has been treated or coated to make it non-stick. Alternative to parchment paper is wax paper, which is paper that has been made moisture-proof through the application of wax. Alternative to parchment paper is acetate paper, which is a transparent material that is made by reacting cellulose with acetic acid in the presence of sulfuric acid.

In one embodiment, the sheets 535, 560 comprise foil backed parchment paper, which comprises an aluminum foil side that easily molds to the shape of a container then holds its shape, and a parchment paper side that does not stick to a container.

By utilizing two insulated foil backed parchment paper with vented holes or orifices for escaping moisture, the claimed embodiments address the issues associated with transporting pizzas and food items safely—heat loss, excessive moisture and damage to the box from oil. The claimed embodiments allow heat to be redirected back into the food, and not out through the box edges. The venting orifices or holes are designed to allow moisture to escape away from the food and be absorbed into the insulated top sheet. The bottom sheet may not be vented, keeping the crust of a pizza, for example, hot and crispy by locking in the heat from escaping through the cardboard of the box and blocking oils or sauces from entering into the cardboard of the box, which preserves the box for recycling.

Tests performed used the claimed embodiments show that food can be kept at least at the recommended standard of 140 degrees for long periods of time, using the claimed box system. Tests performed used the claimed embodiments show that food can also be kept at a 10-12-degree higher temperature of 152-154 for long periods of time. Systems that do not use the claimed embodiment result in food temperatures well below the 140-degree mark (from 95 to 120 degrees), inviting food borne bacterial growth.

Foil backed parchment paper with vented holes or orifices for escaping moisture allows moisture to exit up and through the aluminum foiled inserts. Without these vented holes, condensation cannot exit freely enough. Without these vented holes, the adhesion effect applies, and droplets of rain develop and falls back into the food in the box. Venting must occur equally and evenly related to the top insert.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system for addition to a box for transporting food, the system comprising:
(a) a first sheet composed of a first layer of nonstick aluminum and a second layer of parchment paper, wherein the second layer of the first sheet is configured for being removably coupled to an interior surface of a top portion of the box;
(b) a second sheet composed of a first layer of nonstick aluminum and a second layer of parchment paper, wherein the second layer of the second sheet is configured for being removably coupled to an interior surface of a bottom portion of the box;
(c) wherein the first sheet includes a plurality of orifices configured for allowing moisture to escape therethrough.

2. The system of claim 1, wherein the second layer of the first sheet includes printed material configured for advertising.

3. The system of claim 2, wherein the second layer of the second sheet includes printed material configured for advertising.

4. The system of claim 3, wherein the first sheet is coextensive with the top portion of the box.

5. The system of claim 4, wherein the first sheet is coextensive with the bottom portion of the box.

6. A system for addition to a box for transporting food, the system comprising:
(a) a first sheet composed of a first layer of nonstick aluminum and a second layer of acetate paper, wherein the second layer of the first sheet is configured for being removably coupled to an interior surface of a top portion of the box;
(b) a second sheet composed of a first layer of nonstick aluminum and a second layer of acetate paper, wherein the second layer of the second sheet is configured for being removably coupled to an interior surface of a bottom portion of the box;
(c) wherein the first sheet includes a plurality of orifices configured for allowing moisture to escape therethrough.

7. The system of claim 6, wherein the second layer of the first sheet includes printed material configured for advertising.

8. The system of claim 7, wherein the second layer of the second sheet includes printed material configured for advertising.

9. The system of claim 8, wherein the first sheet is coextensive with the top portion of the box.

10. The system of claim 9, wherein the first sheet is coextensive with the bottom portion of the box.

11. A system for transporting hot food comprising:
(a) a box having a top portion and a bottom portion, wherein the bottom portion is hingedly attached to the box, and the top portion is configured for opening to gain access to an interior volume of the box;
(b) a first sheet composed of a first layer of nonstick aluminum and a second layer of parchment paper, wherein the second layer of the first sheet is configured for being removably coupled to an interior surface of a top portion of the box;
(c) a second sheet composed of a first layer of nonstick aluminum and a second layer of parchment paper, wherein the second layer of the second sheet is configured for being removably coupled to an interior surface of a bottom portion of the box;
(d) wherein the first sheet includes a plurality of orifices configured for allowing moisture to escape therethrough.

12. The system for transporting hot food of claim 11, wherein the box is configured such that the top portion of the box may pivot between an open position and a closed position.

13. The system for transporting hot food of claim 12, wherein the interior volume of the box is configured for storing at least one food item.

14. The system of claim 13, wherein the second layer of the first sheet includes printed material configured for advertising.

15. The system of claim 14, wherein the second layer of the second sheet includes printed material configured for advertising.

16. The system of claim 15, wherein the first sheet is coextensive with the top portion of the box.

17. The system of claim 16, wherein the first sheet is coextensive with the bottom portion of the box.
